(19) United States
(12) Patent Application Publication
(10) Pub. No.: US 2012/0269957 A1
(43) Pub. Date: Oct. 25, 2012

(54) Method for Conditioning the Surfaces of Dental Components

(75) Inventors: Aurica Zothner, Rostock (DE); Michael Hopp, Berlin (DE)

(73) Assignee: DCM GmbH, ROSTOCK (DE)

(21) Appl. No.: 13/258,747

(22) PCT Filed: May 31, 2010
(86) PCT No.: PCT/DE2010/000636

§ 371 Date: Dec. 6, 2011

(30) Foreign Application Priority Data
Jul. 14, 2009 (DE) 10 2009 033 901.9
Oct. 30, 2009 (DE) 10 2009 051 655.7

(51) Int. Cl. B05D 5/10

(52) U.S. Cl. 427/2.29

(57) ABSTRACT

In a method for conditioning the surfaces of dental components of oxide ceramic materials based on zirconium dioxide, ZrO₂, a thin layer of a ceramic solder is applied on at least one of the surfaces to be joined with one another, and the component is then subjected to a ceramic firing, whereby a glass ceramic layer is produced on its surface. The ceramic solder is preferably applied by means of a spraying technique, the thickness of the thusly produced glass ceramic layer can amount to less than 20 μm. The conditioning treatment can be carried out for preparing crowns before their mounting, also before a subsequent veneering or after a veneering of the crowns. Similarly it can be carried out for preparing abutments and for preparing single- or multi-wing adhesive bridges.

The invention relates to a method for conditioning the adhesive bond of the surfaces of dental components made of oxide ceramic materials based on zirconium dioxide, which do not comprise a glass matrix and are to be joined or bonded by means of a composite adhesive.

The adhesive anchoring of ceramic restorations in the dental area on correspondingly prepared tooth stumps or implants by means of an adhesive is a widely used technique in dental medicine. Thereby, ceramic inlays, veneers, partial crowns and crowns as well as so-called Maryland bridges and conventional bridges are adhesively bonded.

An important pre-condition for producing a functional adhesive bond is the conditioning of the surfaces that are to be adhered with one another, in order to achieve a chemical bond or compound. For glassy as well as glass ceramic dental components with a higher glass proportion, after a surface roughening or respectively after an etching with a hydrofluoric acid preparation of low concentration, a silanization, that is to say the chemical bonding of a silane compound onto the surfaces for forming a compound layer between the inorganic glass surface and the organic composite material used as an adhesive, can be carried out. Because silanes are macromolecules with bifunctional end groups, thereby a bonding or compounding with both inorganic as well as with organic structures is possible. For pure oxide ceramic materials without a glass matrix, such as ceramics of zirconium dioxide, however, due to the high chemical inertness of these oxide ceramics, there is the problem that no chemical reaction partner is available for the bonding by means of one of the light-curing or light-hardening dual cements that are typically used for the securing. Thus, with the previously known methods for adhesive bonding of zirconium dioxide restorations, a purely mechanical bond arises, which has only a limited strength, which in turn can lead to the formation of gaps or cracks with all disadvantages in the biological area, such as for example, the formation of secondary cavities or caries.

In the EP 1 908 433 A1, a method of the above initially mentioned type for the production of a dental bridge sub-structure has been suggested, in which a primary and a secondary part of a bridge, which respectively consist of zirconium dioxide, are connected or bonded with one another by means of a ceramic solder in a ceramic firing.

In this context, it is the object of the invention to provide a method for conditioning the surfaces of dental components of oxide ceramic materials based on zirconium dioxide, ZrO₂, which makes possible a significant improvement of the adhesive bonding of these materials both for a cladding or veneering of silicate oxidic materials as well as an improved preparation for the subsequent adhesive bonding with composite glues with adhesive effect.

The invention achieves this object in that, in such a method, a thin layer of a ceramic solder is applied on at least one of the surfaces that are to be bonded or joined with one another, and the at least one coated component is thereafter subjected to a ceramic firing, in which a glass ceramic layer with a thickness of less than 20 μm is produced on the surface thereof. This glass ceramic layer produced by the ceramic firing is anchored with the substrate in an integral or cohesive material-joining manner by diffusion. It can be used as a base for adhesive bonding with adhesive materials, i.e. composites, on the natural tooth, for the cladding or veneering of the ZrO₂ substructures with adhesive dental-technology veneer materials, or for an adhesive bonding of thusly prepared parts of zirconium dioxide with one another by adhesive materials after a silanization. Preferably, a ceramic solder of a glass system based on silicon dioxide is used in the inventive method.

Because ceramic restorations of zirconium dioxide materials, that is to say materials that generally consist of approximately 95 weight percent or more of zirconium dioxide, can be coated with glassy liners or bonders, and these are highly wetting, in this manner a thin glassy bonding layer of a ceramic solder can be produced for example on the inner side of crowns or on other surfaces to be adhesively bonded, which bonding layer after the ceramic firing leads to a diffusion-anchored glass ceramic intermediate layer on these adhesive surfaces of the zirconium dioxide component. The latter can subsequently be structurally etched with a hydrofluoric acid preparation typical in the trade and silanized, and then serve as a basis for a subsequent chemical bond, to be produced by a composite adhesive, with the tooth stump or the like that is to be taken care of. At the same time, the inventive method for pre-conditioning can also be carried out for improving the adhesive bond in connection with the cladding or veneering of crowns. The ceramic firing of the joint surfaces in that regard can occur both before as well as after the application of a veneer ceramic.

In that regard it has been shown to be especially advantageous in connection with the method according to the invention, if the layer is applied by means of a spraying technique while using a so-called airbrush pistol. The layer thickness produced thereby lies at less than 20 μm according to the invention, in order not to limit the fitting of the components both on the natural tooth as well as with one another in connection with material adhesive joints, but simultaneously to ensure a sufficient layer thickness for the previously described process, which leads to a bond with a very high bonding strength.

The inventive process is furthermore usable in the same manner also for the surface conditioning of so-called abutments. The latter, in implant restorations, form the connection element between an implant and the superstructure. In this case, the conditioning method according to the invention is carried out for preparing the abutments before the adhesive bonding or respectively before further modification through soldering with individually configured caps or coverings or overlays.

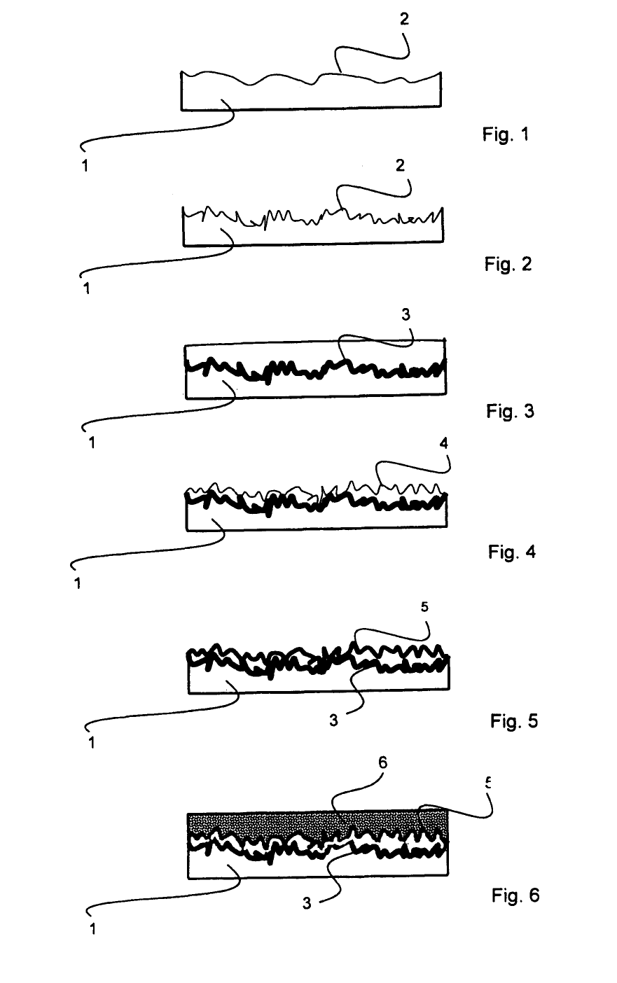

In the following, the invention shall be explained in detail in connection with the drawing. In that regard, the FIGS. 1 to 6 show, in individual steps in a schematic illustration, the progression or sequence of the method with regard to a bonded joint to be produced, namely:

FIG. 1 a vertical section through a dental component of zirconium dioxide after its production for example by means of a CAD/CAM method,

FIG. 2 a section through the surface according to FIG. 1 after the sandblasting,

FIG. 3 a further section after the firing of a ceramic solder,

FIG. 4 a section through the surface according to FIG. 3 after the sandblasting and etching of the ceramic solder,

FIG. 5 a further section through the same surface after the subsequent silanization, and

FIG. 6 a section through the surface according to FIG. 5 after the completed application of a composite adhesive and the connection or bonding with a secondary structure.

In the figures, the same elements are provided with the same reference numbers.

According to the method progression or sequence illustrated in the figures, the dental component 1, which is later to be adhesively bonded, is first produced by a suitable method, for example by means of CAD/CAM, out of an oxide ceramic material based on zirconium dioxide, ZrO₂, which contains at least 95 weight percent of zirconium dioxide, and is manually post-processed or re-worked if applicable. Its surface 2 then at first comprises the structure illustrated in the vertical section in FIG. 1, which structure has the typical machining tracks necessitated by the CAD/CAM production process. This surface 2 is post-processed or re-worked (FIG. 2) by means of sandblasting, for example with corundum of a particle size of 110 to 125 μm and with a pressure of approximately 2 bar in the case of the example embodiment described here.

Onto the thusly prepared surface 2, a ceramic solder, the product “ZirConnect” of the company DCM GmbH, Rostock, in the case of the example embodiment described here, is applied in a spraying technique with the aid of an airbrush pistol in a thin but covering manner, and is allowed to dry. Next, the component 1 coated in this manner is subjected to a ceramic firing at approximately 1000° C. in this case, through which a thin diffusion zone is formed. The thickness of the glass ceramic layer 3 arising thereby on the surface of the dental component 1 amounts to less than 20 μm in the case of the example embodiment described here. The surface of the dental component 1, consisting of the glass ceramic layer 3, is very smooth and structureless, as is indicated in FIG. 3. The coating or covering of the sealed area is defect-free, the utilized ceramic solder achieves a good wetting of the zirconium dioxide surface in all examined areas. A chemical dissolving of the zirconium dioxide at the edges of the dental component 1 does not arise. The utilized ceramic solder is completely molten through at the selected processing temperature and thereby has uniformly sealed the zirconium dioxide surface.

Thereafter the surface of the dental component 1 is again sandblasted and a macrostructure is produced, as well as thereafter etched, in this case by the application of a diluted hydrofluoric acid preparation 4. Through the etching process, there arises a marked or clearly developed micro-fine retentive structure, which offers many anchoring possibilities for the subsequent adhesive bonding. Next the surface to be conditioned is silanized, that is to say a silane compound is applied on the surface of the glass ceramic layer 3, whereby a thin layer 5 with chemical anchoring is produced. Insofar as the dental component 1 to be bonded involves crowns or a bridge construction of zirconium dioxide ceramic to be applied, a composite adhesive, in this case a light-hardening dual cement, is applied before the final installation in a patient, and the dental component 1 provided with the silane layer 5 is adhesively bonded with a correspondingly prepared secondary structure 6.

1. Method for conditioning the adhesive bonding of the surfaces of dental components of oxide ceramic materials based on zirconium dioxide, which do not comprise a glass matrix and which are to be bonded by means of a composite adhesive, characterized in that a thin layer of a ceramic solder is applied on at least one of the surfaces that are to be joined with one another, and the at least one coated component is subsequently subjected to a ceramic firing, by which a glass ceramic layer with a thickness of less than 20 μm is produced on the surface thereof.

2. Method according to claim 1, characterized in that a ceramic solder of a glass system based on silicon dioxide is used.

3-8. (canceled)
